(19) United States
(12) Patent Application Publication
(10) Pub. No.: US 2004/0024842 A1
(43) Pub. Date: Feb. 5, 2004

(54) Validation framework for validating markup page input on a client computer

(75) Inventor: Evan Witt, Chicago, IL (US)

Correspondence Address: Finnegan, Henderson, Farabow,, Garrett & Dunner, L.L.P., 1300 I Street, N.W., Washington, DC, 20005-3315, US

(73) Assignee: SAP Aktiengesellschaft

(21) Appl. No.: 10/207,804

(22) Filed: Jul. 31, 2002

(51) Int. Cl. G06F 15/16

(52) U.S. Cl. 709/219

(57) ABSTRACT

A server computer with an application and a client computer with a browser communicate over a network, such as the Internet. The server computer sends a behavior rule file to the client computer. The server computer also sends a markup language page (such as an HTML page) to the client computer. The page has at least one input field code. The client computer identifies a rule in the rule file from attributes in the input field code, applies the rule to the input field, and provides a message to the user of the client computer depending on a result of the rule application.

### BACKGROUND OF THE INVENTION

I. Field of the Invention

The present invention generally relates to data processing and, more particularly, the invention relates to computer systems, computer programs, and methods for validating data input for client/server applications, such as Internet applications.

II. Background Information

The use of electronic media to convey information among networked users has become vital in many applications. One way of conveying such information is through the Internet. The Internet is a distributed network of computers that provides a worldwide information resource to users. The Internet has experienced exponential growth that has been fueled by the phenomenal popularity of the World Wide Web (the “Web”). On the Web, the ease of self-publication via user-created “Web pages” has helped generate tens of millions of documents on a broad range of subjects, all capable of being displayed for a computer user with access to the Web.

Users can access information on the Web using standard computer equipment, such as a personal computer with a display and modem connected to the Internet. Several types of Internet connections are available, including connections through Internet Service Providers (ISPs). To use an Internet connection from an ISP, for example, a user can electronically connect his personal computer to a server at the ISP's facility using the modem and a standard telephone line or a local area network (LAN) connection. The ISP's server in turn provides the user with access to the Internet.

Typically, a user accesses information using a computer program called a “Web browser.” A Web browser provides an interface to the Web. Examples of Web browsers include Netscape Navigator™ from Netscape Communications Corporation or Internet Explorer™ from Microsoft Corporation. To view a Web page, the user uses the Web page's Uniform Resource Locator (URL) address to instruct the Web browser to access the Web page. The user, via the Web browser, can view or access an object in the Web page, for example, a document containing information of interest. The Web browser retrieves the information and visually displays it to the user.

A Web page can be a document, and information contained in a Web page is commonly referred to as “content.” Web pages are programmed using a computer language such as hypertext markup language (HTML). HTML files (or “.htm” files) are stored on a server (“Web server”) and define the content and layout of Web pages. When a user enters a URL address into a Web browser, the URL address is used by the Web browser to locate a Web page stored on a Web server.

Communication between the user's browser and a Web server is based on a request/response paradigm involving Hypertext Transfer Protocol (HTTP). When an HTTP request is made by the browser (such as to view a Web page), the Web server provides a response (to permit the Web page to be displayed by the browser). As a result, such interactions follow a client/server relationship, in which the browser on a user's computer serves as the “client” and a Web server acts as the “server.”

One form of facilitating content on the Web via a Web browser is Internet Applications. Internet applications are software applications that are run over the Internet, through the Web browser. Internet applications have several advantages over standard software applications. For instance, Internet applications may take the processing load off of a user's computer. A version of a program, such as Adobe® Photoshop®, may work best with 512 MB of RAM and 2 GHz processor and a large amounts of disk space. By making this desktop software program an Internet application, a user would not need to meet these requirements. Generally, they may only need a moderately good computer and an Internet connection. Further, Internet applications can store files on a central server, further allowing users to work from any terminal instead of only their home or work computer.

The Web interface is becoming familiar and comfortable to users. The Web interface takes advantage of the use of Internet technology, such as HTML and Javascript, to standardize programming across computer platforms of users. The ease of sharing data, scalability and other factors, such as the standardization of Web programming languages and growing familiarity of Web interfaces, will likely make Internet applications a leading kind of software application.

Internet applications continue to evolve and are capable of providing complex functionality. Functional applications, however, often require user input that is returned to the server and processed by the application. Input data from the user may comprise alphanumeric data, such as calendar dates (e.g., 5/21/2002 or May 21, 2002), hour-and-minute time designations (e.g., 08:00 AM), numbers (e.g., a postal code), or letters (e.g., ABC) to specify a name, address and the like. Typically, the complexity of the user input increases with added functionality. Complex input necessitates validation to ensure data quality of the user input. In order for a software application to be usable, this validation must occur quickly and consistently across all screens of the application.

Validation may occur at the client computer or server computer. For example, the client computer may verify that a postal code entered by a user has exactly a predetermined number of digits, or the server computer may confirm that the corresponding city matches. Generally, client-side validation is quicker and, therefore, preferred. Unfortunately, client-side validation historically has been coded into each Web page separately. For instance, the appropriate routines are explicitly added into each screen and associated with the appropriate events. This approach increases development time and susceptibility to bugs, while lessening the complexity of validation that can be incorporated into a Web page. A robust client-side validation framework would provide several benefits to any Internet application development team and enable greater functionality to be developed in a shorter period of time.

In addition to the need to provide quick validations, any validation must be consistent across all screens of an Internet application. This is because most users expect similar or equal behavior of similar or equal screen elements on different screens of an application. For example, if a user age restriction in a trade application is 18 years of age, this age restriction should be consistently applied such that any user under 18 years of age is excluded from trade on all presentations. If a change is made to a screen element, then this change must be consistently applied to all pages of the application. For instance, if the age limit is reduced to 16 years of age, then this change must be consistently applied everywhere. However, using previous validation schemes, making such an update is time consuming and prone to error since the code for every page would need to be changed.

### BRIEF DESCRIPTION OF THE DRAWINGS

The accompanying drawings, which are incorporated herein and constitute a part of this specification, illustrate various features and aspects of embodiments of the present invention. In the drawings:

FIG. 1 illustrates a general block diagram of an exemplary computer network system for implementing embodiments of the invention;

FIG. 2 illustrates a block diagram of an exemplary client-server environment, consistent with an embodiment of the invention, in which a server computer sends a validation rule file and a markup page to a client computer in order to provide a presentation to a user;

FIG. 3 illustrates a flow chart of an exemplary method for operating a client computer and a server computer, consistent with an embodiment of the invention;

FIG. 4 illustrates a diagram of an exemplary validation rule file;

FIG. 5 illustrates a code example for a page file;

FIG. 6 illustrates an exemplary presentation by a browser on a client computer at a first time point;

FIG. 7 illustrates an exemplary presentation by the browser on the client computer at a second time point, wherein the presentation includes a message to the user;

FIG. 8 illustrates a flow chart an exemplary method related to the operation of a browser that interprets a page and a behavior file; and

FIG. 9 illustrates an exemplary bar chart presentation of calendar dates.

### DETAILED DESCRIPTION

Embodiments of the present invention provide a validation framework for validating input at a client computer. Such embodiments may be used in connection with validating a markup language page, such as HTML pages, used in Internet applications. In accordance with an embodiment of the invention, a validation framework is provided that isolates the definition of the validation routines and events with which they are associated from the input screen at the client computer. Embodiments of the invention may be implemented to provide: consistent behavior throughout the screens; the ability to update the validation behavior of all screens by only changing one file; and/or an efficient and simple framework for adding validation routine(s) to new or existing screens. Embodiments of the invention may also be implemented to provide both simple and complex validation that involves cross-field checking and/or to allow for multiple validation types to be added to one field.

In accordance with an embodiment of the invention, a method is provided for operating a client computer and a server computer. The method comprises: sending a validation rule file from the server computer to the client computer; sending a markup language page from the server computer to the client computer; receiving a first input value X by the client computer, the first input value X corresponding to a first input field represented in the page by first input field code; receiving a second input value Y by the client computer, the second input value Y corresponding to a second input field represented in the page by second input field code; identifying a rule in the validation rule file from attributes in the first input field code and in the second input field code; applying the rule to the first input value X and to the second input value Y; and providing a message to the user of the client computer depending on a result of the rule application.

The above-described method contributes to solving the drawbacks found in past approaches to validation. For instance, the method provides a validation framework to ensure data quality of user input, even when the user input requires high complexity. In addition, validation of the user input may be performed fast on the client side and consistently across all screens of an application. Further, there is no longer a need to code validation routine(s) into each page separately. Instead, appropriate validation routines may be explicitly provided as part of a validation rule file and associated with appropriate events. Moreover, consistent with the invention, development time and susceptibility to bugs is decreased and the difficulty of adding complex validation is reduced.

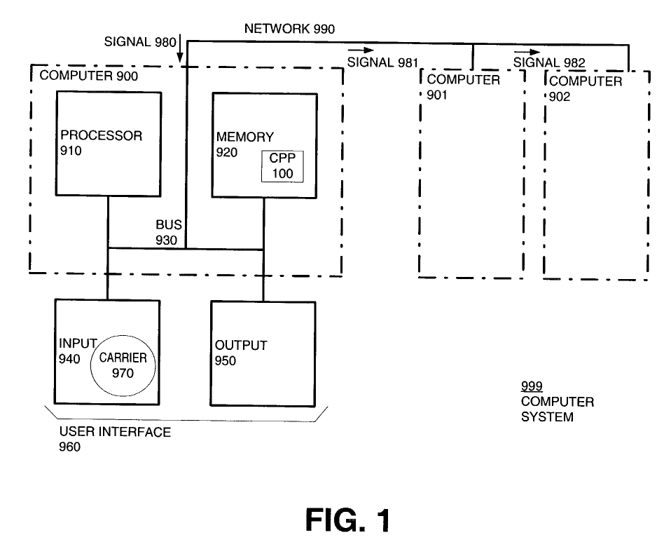

In one embodiment of the invention, the validation method is performed such that a validation rule file is sent to the client computer and, thereafter, one or more markup language pages are sent to the client computer. The validation rule file includes coded validation rule(s) or routine(s) that cause the client computer to validate user input. In certain applications, the validation rule may change only from time to time, for example, once a week. In such cases, the client computer may store the validation rule file for a predetermined time period (e.g., a day, a week, etc.), before replacing the validation rule file with an updated one. Updating influences the operation of the user's browser that interprets pages received after the update. In one embodiment, the validation method may receive input values for validation by receiving values from the user who operates a keyboard. The keyboard may be implemented by hardware (cf. FIG. 1) or through a software-emulation on the screen.

Consistent with an embodiment of the invention, the client computer may identify the rule in the validation rule file by interpreting a JavaScript file. JavaScript is a script language that may be embedded with HTML markup language. Script technology is also applicable for other language pairs.

In another embodiment of the invention, the step of applying a validation rule comprises validating input values X, Y of each input field separately. For example, for numbers-only input fields (e.g., for age), a validation rule may cause the browser to reject letter characters. Multiple validation rules can be applied for each field, such as to validate the format and to validate a magnitude.

In one embodiment, the step of applying the rule comprises validating input values X, Y for both input fields in combination. By way of a non-limiting example, details of an illustrative approach are explained below in connection with an exemplary embodiment that compares dates X and Y.

In another embodiment of the invention, the input field code is a markup code (e.g., HTML) and the attributes are part of the markup code. As part of the markup code, the attributes are preferably located inside < >tags.

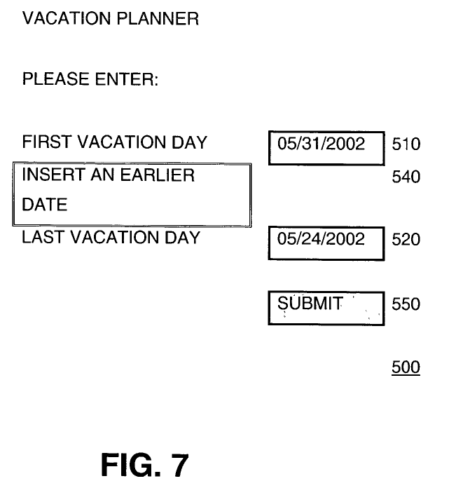

In still another embodiment, a message is provided with an indication of the input field to specify that the rule has been applied. This feature is convenient, and may be supported by the “name code” attribute. Such a message may be displayed or indicated by the corresponding field (cf. FIG. 7).

In one embodiment, the input field code may comprise further attributes to cross-reference the first and second input values.

In another embodiment, the first input field code and the second input field code are represented in the page by code that causes the browser in the client computer to generate code upon receiving the page. In other words, input field codes can be created explicitly. In one embodiment, the rule file binds the rules to functions in libraries.

In one embodiment, the step of applying the rule is event-triggered. For example, application of a validation rule may be triggered upon detection of predetermined user interaction. The predetermined user interaction may comprise: operating a submit button, operating a predetermined key on a computer keyboard, and/or leaving the input field.

In another embodiment of the invention, the first and second values are first and second calendar dates, the condition (i.e., for the warning message) are, for example: the first date antecedes the second date (e.g., May 31 antecedes May 24); the first date precedes the second date; the first date and the second date coincide; an input number for a day is larger than 31 or smaller than 1; an input number for a month is larger than 12 or smaller than 1 and so on.

In one embodiment, the first and second values are first and second time values, such as hour-and-minute values. By way of a non-limiting example, a first input field may represent the start time of a mandatory activity. The validation may ensure that the field represents a time value, that the value is not omitted, and/or that it is earlier than the end time (represented by the second input field). The validation routine(s) may be bound to the input using, for example, the following syntax: <input type=“text” id=“activityStart” validationType=“required,time,lessThanOther” val_otherTime=“activityEnd”>. In this example, the attribute “validationType” can be a comma delimited list of the types of validation that should be added to the field. For complex validation types that require parameters, attributes can be set to provide the necessary information. In the noted example, the input field needs to be less than the activity end time. The “lessThanOther” validation type needs to know where the other field is in order to check the condition. The “lessThanOther” looks for an attribute called “val_otherTime,” which represents the ID of the end time. Therefore, all the information that is needed to run the test is available within the < >tags.

In the above-noted example, the validation framework support the validation types “required,” “time,” and “lessThanOther.” Consistent with embodiments of the invention, numerous approaches may be used to create the necessary validation types. For example, one may first create all of the validation routines that would have to be done regardless of whether the validation framework is used. In the noted example, assume that standard validation routines are written which are called “timeCheck” and “formatTime.” The routines may use one input element as an argument and validation may occur based on the given input field's value. For instance, the timeCheck function may verify that the value is a valid time. Further, the formatTime function may be called when the value is changed. If the value is not in the standard format, the formatTime function may put it into standard format.

The following is an example of the code that could be used to attach routines to the time type:

// creates the validation type time. The first argument is the
// name of the default validation routine.
var time = new ValidationType(timeCheck);
// causes function format time to be run
var changeEvent = new EventFunction(“onchange”,
formatTime);
// add this routine to time validation type
time.eventValidationList.push(changeEvent);

Consistent with an embodiment of the invention, validation routines can be added to new fields that are created dynamically from a user action. For example, if a user clicks a button to add a new activity or event, new input fields may appear on the screen. These new fields can use the validation framework comprising the rule file.

Embodiments of the present invention also relate to systems, methods and computer programs for validating input and/or controlling behavior at a client computer. In such embodiments, a behavior rule file and markup language page are sent from a server computer to the client computer. The markup page may include at least one input field code. At the client computer, at least one rule in the behavior rule file is identified from attribute(s) in the input field code and the rule is applied to the input field. Thereafter, a message is provided to the user of the client computer depending on a result of the application of the rule. In one embodiment, the behavior rule file is a validation rule file.

Numerous advantages can be achieved from practicing embodiments of the present invention. For example, in accordance with an embodiment of the invention, the person writing or coding the page does not need knowledge in writing JavaScript. For instance, having separate page and behavior files allows one to efficiently divide development work between specialists, i.e., between the specialist for the page (e.g., HTML) and the specialist for the behavior file (e.g., JavaScript). In accordance with another embodiment of the invention, it is advantage that once changes are made to the rules, the updates are applicable to all pages; in that case, the developer of the page is alleviated from adapting each page.

FIG. 1 illustrates a general block diagram of an exemplary computer network system 999, consistent with embodiments of the invention. As illustrated in FIG. 1, computer network system 999 comprises a plurality of computers 900, 901, and 902 that are coupled via inter-computer network 990. As further described below, inter-computer network 990 may comprise a public or private network, such as the Internet or a private intranet. Computer 900 comprises a processor 910, a memory 920, a bus 930, and, optionally, an input device 940 and an output device 950 (I/O devices, user interface 960). Similar components may also be provided in computers 901 and 902. In example of FIG. 1, embodiments of the invention may be implemented by one or more computer program products 100 (CPP), program carriers 970 and/or program signals 980, collectively “program”. More details concerning computer network system 999 are given at the end of the description.

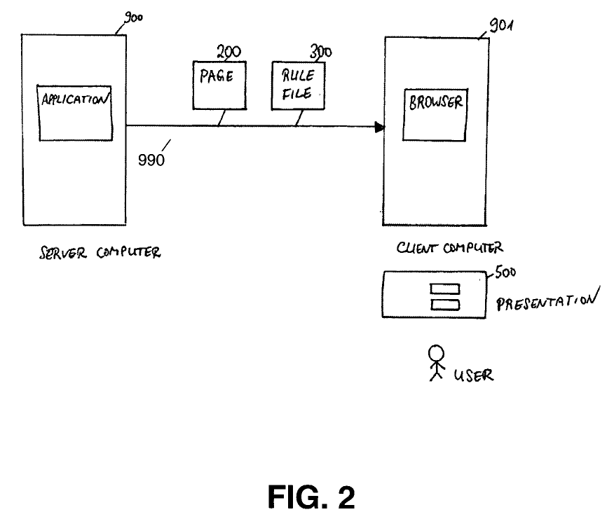

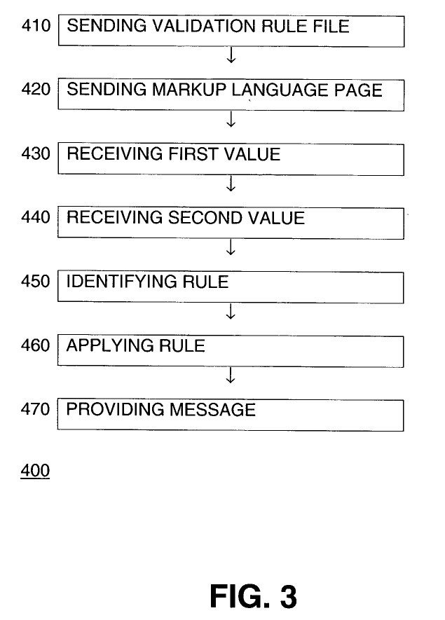

FIG. 2 illustrates a diagram of an exemplary client-server environment, in which a server computer 900 and a client computer 901 are coupled via an inter-computer network 990, such as the Internet or a private intranet. As illustrated in FIG. 2, server computer 900 sends a rule file 300 and page 200 to client computer 901. Server computer 900 may store or host an application (such as an Internet application) for client computer 901. Page 200 may be a file containing-a markup language (such as HTML) that causes a browser on the client computer 901 to generate and provide a presentation 500 to a user. Presentation 500 may be provided on a display screen or another suitable output device of client computer 901. Rule file 300 may be used by client computer 901 to validate input or control behavior of the presentation. Computers 900 and 901 may be implemented to perform methods consistent with the present invention, such as validation method 400 (cf. FIG. 3) further described below.

For purposes of illustration, assume in the example of FIG. 2 that both server computer 900 and client computer 901 belong to an enterprise. The application on computer 900 may store employee information, such as vacation plans or project deadlines. By sending page 200, server computer 900 invites the user of client computer 901 to enter the appropriate values (such as vacation dates, time values, etc.). Entry of such data may then be validated by client computer 901 using the rule file 300 sent from server computer 900.

Validation routines may be triggered by an event to which they are bound or by running a default validation, which may be done by calling, for example, a JavaScript function. By way of a non-limiting example, default validation may be performed before a form or input is submitted (e.g., triggered by the clicking of a SAVE button by the user). If there are errors, the form is not submitted and a message may be provided to identify the errors for the user to correct before resubmitting the form.

In one embodiment, certain validation routines that are called by events in an application may trigger automated reformatting. For example, if a user enters a time value “10:00” but does not specify AM or PM, a validation routine may be provided to automatically reformat the data by assuming AM and adjusting the value to “10:00 AM.” In another embodiment, the validation framework may be implemented such that it does not override other events. For example, if the validation framework triggers a function “onchange” and the user wants to add other functionality to the “onchange” event, both pieces of functionality will be performed.

Consistent with an embodiment of the invention, FIG. 3 illustrates a flow chart of an exemplary method 400 for operating a server computer and a client computer. For purposes of illustration, method 400 will be described with reference to server computer 900 and client computer 901. In step 410, server computer 900 sends a validation rule file 300 (or, generally, a behavior rule file) to client computer 901. In step 420, server computer 900 sends a markup language page 200 to client computer 901. In one embodiment, steps 410 and 420 are performed by a server computer 900. In another embodiment, steps 410 and 420 may be performed by different server computers (e.g., one server computer that stores page 200 and another server computer that stores rule file 300). In addition, consistent with an embodiment of the invention, the order of steps 410 and 420 may be performed such that either the validation rule file 300 or the page 200 is sent first to the client computer.

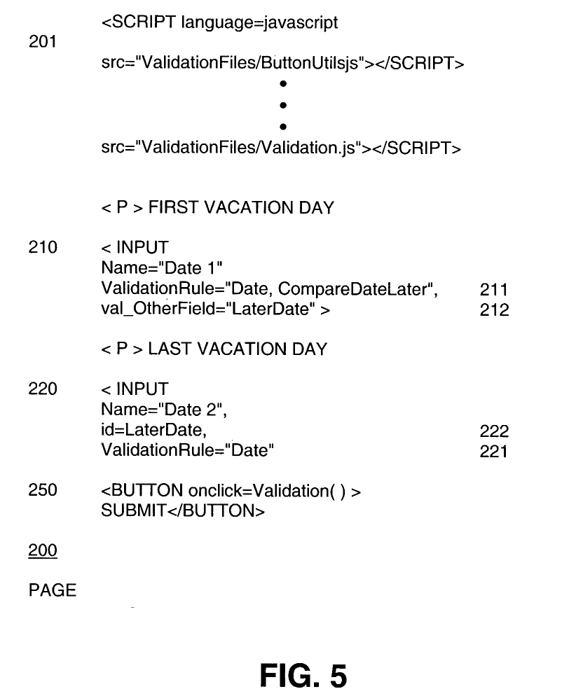

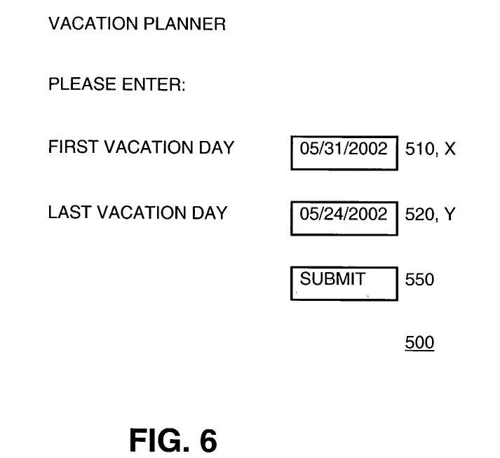

Referring again to FIG. 3, at step 430, client computer 901 receives a first input value X that corresponds to first input field 510 (cf. FIG. 6). The first input value X may be represented in page 200 by first input field code 210 (cf. FIG. 5). In step 440, client computer 901 receives second input value Y that corresponds to second input field 520 (cf. FIG. 6). The second input value Y may be represented in page 200 by second input field code 220 (cf. FIG. 5). In step 450, client computer 901 identifies a rule (e.g., CompareDateLater) in validation rule file 300 from attributes 211, 221 (in input field code 210, 220). In step 460, client computer 901 applies the rule to first input value X and second input value Y. Thereafter, in step 470, client computer 901 may provide a message 540 to the user depending on the result of applying the rule from the validation rule file 300. Such a message may indicate whether an error has occurred in the input provided by the user.

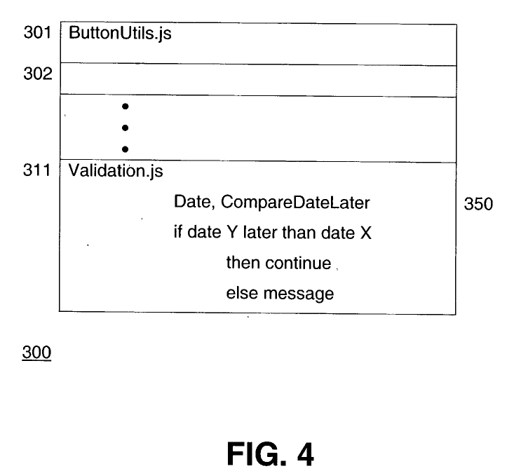

FIG. 4 illustrates a diagram for an exemplary validation rule file 300. As shown in FIG. 4, validation rule file 300 may include a number of portions 301-311. The code for portions 301-311 may be stored as part of one file or, optionally, portions 301-311 can be stored as separates files, for example, JavaScript files, with file extension “.js.” The following is a list of exemplary JavaScript files with a short description of their associated function(s) in parenthesis: ButtonUtils.js 301 (e.g., detecting the presence of the mouse over an input field); Comparator.js 302 (e.g., comparing numerical values, such as checking that two numerical values are of the same type, such as both integers); Date.js 303 (e.g., verifying the existence of a numerical value; triggering an error message for non-existence of a value; parsing a string to convert a string like “August” to a numerical value like “8”; checking the validity of a date format, such as “MM/DD/YYYY”; converting a value to a correct date format); DateScroller.js 304 (e.g., adapting to local date input style, for example, to convert 31.12.2002 to read as 12/31/2002); Dirtyform.js 305 (e.g., preventing the user to navigate from page 200, unless the user agrees after providing a warning message like “Do you want to leave this screen?”); Error.js 306 (e.g., error message generation; using name identification in attributes to provide message); Fractional.js 307 (e.g., handing over the input value to message, for example, user inputting “June 31”; message with “June 31 is incorrect”); Keypress.js 308 (e.g., detecting which keys are operated by the user); Number.js 309 (e.g., checking number range; checking decimal points); Percentile.js 310 (e.g., calculating percentages); and Validation.js 311 (e.g., storing exemplary rule 350-cf. FIG. 4).

As shown in FIG. 4, the validation rule file may include one or more behavior or validation rules, including rule 350. In the example of FIG. 4, rule 350 (“Date, CompareDateLater”) compares calendar dates X and Y and can be expressed as “if date Y later than date X then continue else message.” For instance, if the user inputs vacation dates correctly (i.e., last day later than first day), both dates X and Y are accepted. Otherwise, an appropriate message may be generated to notify the user of the error (see, for example, message 540 in FIG. 7).

In one embodiment, rules may be conveniently classified in accordance with a hierarchy, for example, “Date” with “CompareDateLater”, “CompareDateEarlier”, “CompareDateEqual” or the like (cf. Table 1).

FIG. 5 illustrates exemplary code for page 200. As shown in FIG. 5, page 200 may include a number of code portions 201-250. For example, an identification portion such as identification 201 may be provided in page 200 to indicate an address or file name for the validation rule file(s). For instance, identification 201 may identify an Internet address for the portions or files related to validation rule file 300. In the example of FIG. 5, portions “ButtonUtils.js” to “Validation.js” are listed in identification 201.

Other code portions may be provided as part of page 200. For instance, a code portion 210 may be provided for the first input field. As shown in FIG. 5, code 210 includes an attribute 211 to identify a validation rule (e.g., “Date, CompareDateLater”) and an attribute 212 to identify a variable Y (e.g., val_OtherField=“LaterDate”). Further, a code 220 is provided for the second input field and includes an attribute 221 to identify a rule (“Date”) and an attribute 222 to identify the variable X (id=LaterDate). Further, code 250 is provided to code the activation of the validation. In the example of FIG. 5, code 250 activates validation by inviting the user to press a SUBMIT button.

In the exemplary embodiment of FIG. 5, identification 201 can be made part of a <HEADER> portion and code 210-250 could be part of a <BODY> portion.

FIGS. 6 and 7 illustrate exemplary presentations 500 that may be generated by the browser on client computer 901 (e.g., output device 950-cf. FIG. 1) at first and second time points, respectively.

Generally, in FIGS. 6 and 7, first input field 510 accepts the first date or input value X (format “MM/DD/YYYY”) and second input field 520 accepts the last date or second input value Y (same format). A message 540 may be provided to the user (double-line frame in FIG. 7) depending on the results of the validation. A submit button 550 may be provided in the presentation 500 to trigger validation (cf. steps 450-470).

As illustrated in FIG. 6, the user has introduced an error for the first vacation day (DD should be “21”, not “31”). As a result, as shown in FIG. 7, the presentation 500 includes a message 540 (“Insert an earlier date”) to the user informing about the inconsistency. By placing message 540 near to first input field 510 (e.g., below it), the error and the input field in question may be identified by the user.

Table 1 list several exemplary rules that may be provided as part of a validation rule file. The rules are arranged in hierarchy for: (1) comparing times; (2) comparing calendar dates; and (3) comparing numbers. Further classification is possible, for example, for numbers, to distinguish integers and floating point numbers. For convenience, the left column of Table 1 indicates the name of each exemplary rule according to normal conditions (e.g., “earlier” expected) and the right column indicates exemplary triggering or abnormal conditions (e.g., “later” occurred) to trigger message 540.

TABLE 1
Validation Rules

| | |
|---|---|
| Exemplary | Exemplary |
| Rules | Warning Triggering Condition |

1. Comparing Times

| | | |
|---|---|---|
| 1.1. | CompareTimeEarlier | First time later than or equal to |
| | | second time; (e.g., 09:00 vs. 08:00) |
| 1.2. | CompareTimeEqual | First and second time differ; |
| | | (e.g., 09:00 vs. 08:00) |
| 1.3. | CompareTimeLater | First time earlier than or equal to |
| | | second time; (e.g., 08:00 vs. 09:00) |
| 1.4. | CompareTimeEarlierEqual | First time later than to second time; |
| | | (e.g., 09:00 vs. 08:00) |
| 1.5. | CompareTimeLaterEqual | First time earlier than to second |
| | | time; (e.g., 08:00 vs. 09:00) |
| 1.6 | IntervalsNotOverlapping | Time span indicated by a start and |
| | | end time is overlapped by one or |
| | | more other specified intervals |
| | | comprised of a start and end time |

2. Comparing Calendar Dates

| | | |
|---|---|---|
| 2.1 | CompareDateEarlier | First date later than or equal to |
| | | second date; (e.g., May 31 vs. May |
| | | 21) |
| 2.2. | CompareDateEqual | First and second date differ; (e.g., |
| | | May 31 vs. May 21) |
| 2.3. | CompareDateLater | First date earlier than or equal to |
| | | second date; (e.g., May 21 vs. May |
| | | 31) |
| 2.4. | CompareDateEarlierEqual | First date later than to second date; |
| | | (e.g., May 31 vs. May 21) |
| 2.5. | CompareDateLaterEqual | First date earlier than to second |
| | | date; (e.g., May 21 vs. May 31) |

3. Comparing Numbers

| | | |
|---|---|---|
| 3.1. | CompareNumberSmaller | First number X larger than or equal |
| | | to second number Y; (e.g., 4 vs. 3) |
| 3.2. | CompareNumberEqual | First and second number differ; |
| | | (e.g., 4 vs. 3) |
| 3.3. | CompareNumberLarger | First number X smaller than or |
| | | equal to second number Y; |
| | | (e.g., 3 vs. 4) |
| 3.4. | CompareNumberEqualSmaller | First number X larger than second |
| | | number Y; (e.g., 4 vs. 3) |
| 3.5. | CompareNumberEqualLarger | First number X smaller than |
| | | second number Y; (e.g., 3 vs. 4) |

4. Checking Required Fields

| | | |
|---|---|---|
| 4.1 | Required | Field is empty |
| 4.2 | Others Required | Given field is not empty but a |
| | | specified, related field is empty |
| | | (e.g., start time requires end time) |

While embodiments of the invention have been described above with reference to validating two input values or fields, embodiments of the invention are not limited to validating two values. As can be appreciated by persons of skill in the art, further functionality can be added consistent with the teachings herein to provide, for example, the ability to validate or check sequences of three or more input values. Moreover, embodiments of the invention may be implemented to check or validate a single input value or field that occurs on one or more pages. In such embodiments, the format of the input value may be verified, as well as other characteristics such as predefined maximums or minimums, limits on price or quantity, etc.

Although embodiments of the present invention have been described with reference to a rule file 300 that includes validation rules, embodiments of the invention are generally applicable to any markup language elements (e.g., input fields) that change their behavior. For example, effects like changing color on mouse-over can be programmed more efficiently by including the mouse-over detection and color changing code into rule file 300 as behavior rules. A further behavior example is displaying a warning prior to closing a window, a screen or a program. Such a feature may be convenient in combination with control or termination of a browser session (see, for example, publication WO 01/97012). Embodiments of the present invention allow such features to be implemented in combination with behavior rule file 300.

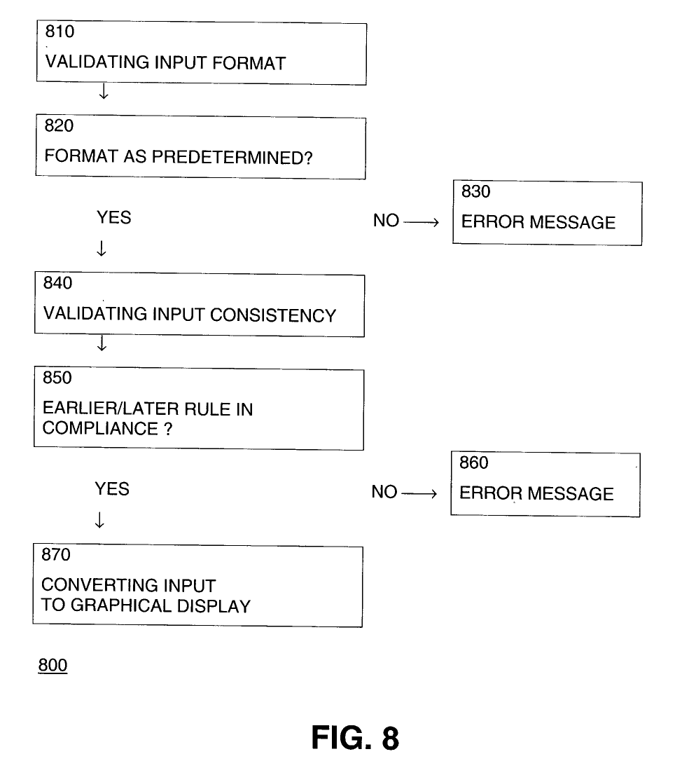

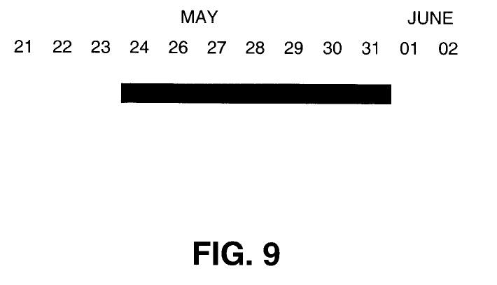

FIG. 8 illustrates a flow chart of an exemplary method 800, consistent with an embodiment of the invention. Method 800 may be implemented with a browser on a client computer that interprets a page 200 and a behavior rule file 300. Using functions in rule file 300, the browser may validate the input format (step 810). If the format corresponds to a predetermined format, e.g., 05/24/2002 and 05/31/2002, both given in the format “MM/DD/YYYY” (step 820; Yes), then the browser may validate the input consistency, e.g., CompareDateEarlier (step 840). If the input complies with the rules (step 850; Yes), the browser converts the input to a graphical representation (step 870). For instance, a calendar bar representation (see, for example, FIG. 9) may be used to graphically represent, validated input corresponding to calendar dates.

If the format does not correspond to a predetermined format, e.g., input 05/32/2002,(step 820; No), then the browser may generate a message to the user, e.g., “Please type a valid date format” (step 830). In one embodiment, format checking may co-exist with presenting a graphical representation (such as a bar chart), and any existing graphical presentation may remain unchanged.

If the input does not comply with the rule (step 850; No), the browser may also give an error message, e.g., “Please input consecutive dates” (step 860). In other words, in case of any non-compliance, the browser may not generate a graphical representation (such as a bar chart or calendar).

FIG. 9 illustrates an exemplary bar chart presentation of calendar dates. In the example of FIG. 9, the bar chart presents a time interval between first and second time points, which may be represented by first and second input values that have been validated. As described above, such a bar chart may be used in connection with a browser that interprets a page and behavior rule file.

Those of skill in the art can apply the principles of separating rules from pages to a variety of applications. To name one further example, the above-mentioned mouse-over help could be diversified for international users. For instance, a first rule file may provide the message in English and a second rule file may provide the message in a different language.

As indicated above, FIG. 1 is a general block diagram of an exemplary computer system environment 999 that may be used to implement embodiments of the invention. As illustrated in FIG. 1, system 999 comprises a plurality of computers 900, 901, 902 (or 90q, with q=0 . . . Q−1, Q any number) that are coupled via an inter-computer network 990, such as the Internet or a private intranet.

Computer 900 comprises a processor 910, a memory 920, a bus 930, and, optionally, an input device 940 and/or an output device 950 (I/O devices, user interface 960). As illustrated in FIG. 1, embodiments of the invention may be implemented through one or more computer program products 100 (CPP), a program carriers 970 and/or a program signals 980, collectively “program.”

With respect to computer 900, computer 901/902 may be referred to as a “remote computer.” Further, computer 901/902 may be implemented with, for example, a server, a router, a peer device or other common network node, and typically comprises many or all of the elements described relative to computer 900. Hence, elements 100 and 910-980 in computer 900 collectively illustrate also corresponding elements 10q and 91-q-98q (shown for q=0) in computers 90q.

Computer 900 may include, for example, a conventional personal computer (PC), a desktop, a hand-held device, a multi-processor computer, a pen computer, a microprocessor-based or programmable consumer electronics, a minicomputer, a mainframe computer, a personal mobile computing device, a mobile phone, a portable or stationary personal computer, a palmtop computer or the like.

Consistent with embodiments of the invention, processor 910 is, for example, a central processing unit (CPU), a micro-controller unit (MCU), a digital signal processor (DSP), or the like.

In FIG. 1, memory 920 symbolizes elements that temporarily or permanently store data and instructions. Although memory 920 is conveniently illustrated as part of computer 906, memory functions can also be implemented in network 990, in computers 901/902, in processor 910 itself (e.g., a cache or register) or elsewhere. Memory 920 can be a read only memory (ROM), a random access memory (RAM), and/or a memory with other access options. Memory 920 may be physically implemented by computer-readable media, such as, for example: (a) magnetic media, like a hard disk, a floppy disk or another type of magnetic disk, a tape, a cassette tape, or the like; (b) optical media, like an optical disk (CD-ROM, digital versatile disk-DVD); (c) semiconductor media, such as DRAM, SRAM, EPROM, EEPROM, a memory stick, etc.; or (d) by any other media, like paper.

Optionally, memory 920 may be distributed across different media. Portions of memory 920 can be removable or non-removable. For reading from media and for writing in media, computer 900 may use devices well known in the art such as, for example, disk drives, tape drives, etc.

Memory 920 stores support modules such as, for example, a basic input output system (BIOS), an operating system (OS), a program library, a compiler, an interpreter, and/or a text-processing tool. Support modules are commercially available and can be installed on computer 900 by those of skill in the art. For simplicity, these modules are not illustrated.

CPP 100 comprises program instructions and—optionally—data that cause processor 910 to execute embodiments of the present invention, such as the steps of the exemplary methods disclosed herein. In other words, CPP 100 defines the operation of computer 900 and its interaction in network system 999. For example and without the intention to be limiting, CPP 100 can be available as source code in any programming language and/or as object code (“binary code”) in a compiled form. Persons of skill in the art can use CPP 100 in connection with any of the above support modules (e.g., compiler, interpreter, operating system).

Although CPP 100 is illustrated as being stored in memory 920, CPP 100 can be located elsewhere. CPP 100 can also be embodied in carrier 970.

In FIG. 1, carrier 970 is illustrated outside computer 900. For communicating CPP 100 to computer 900, carrier 970 may be inserted into input device 940. Carrier 970 is implemented as any computer readable medium, such as a medium largely explained above (cf. memory 920). Generally, carrier 970 is an article of manufacture comprising a computer readable medium having computer readable program code means embodied therein for executing embodiments of the present invention, such as the steps of the exemplary methods disclosed herein. Further, program signal 980 can also embody computer program 100. Signal 980 travels on network 990 to computer 900.

Having described CPP 100, program carrier 970, and program signal 980 in connection with computer 900 is convenient. Optionally, program carrier 971/972 (not shown) and program signal 981/982 embody a computer program product (CPP) 101/102 to be executed by processor 911/912 (not shown) in computers 901/902, respectively.

Input device 940 symbolizes a device that provides data and instructions for processing by computer 900. For example, device 940 may include a keyboard, a pointing device (e.g., a mouse, a trackball, cursor direction keys), a microphone, a joystick, a game pad, a scanner, and/or a disk drive. Although the examples are devices with human interaction, device 940 can also operate without human interaction, such as, a wireless receiver (e.g., with a satellite dish or terrestrial antenna), a sensor (e.g., a thermometer), or a counter (e.g., a goods counter in a factory). Input device 940 can also serve to read carrier 970.

Output device 950 symbolizes a device that presents instructions and data that have been processed. Output device 950 may include, for example, a monitor, a display, a cathode ray tube (CRT), a flat panel display, a liquid crystal display (LCD), a speaker, a printer, a plotter, and/or a vibration alert device. Similar as above, output device 950 communicates with the user, but it can also communicate with further computers.

Input device 940 and output device 950 can be combined to a single device. Alternatively, device 940 and/or 950 can be provided optional.

Bus 930 and network 990 provide logical and physical connections by, for example, conveying instruction and data signals. While connections inside computer 900 are conveniently referred to as “bus 930,” connections between computers 900-902 are referred to as “network 990.” Optionally, network 990 may comprise gateways including computers that specialize in data transmission and protocol conversion.

Devices 940 and 950 are coupled to computer 900 by bus 930 (as illustrated in FIG. 1) or by network 990 (optional). While the signals inside computer 900 are mostly electrical signals, the signals in network may comprise electrical, magnetic, optical and/or wireless (radio) signals.

Networking environments (to implement network 990) are commonplace in offices, enterprise-wide computer networks, intranets and the Internet (i.e., the World Wide Web). The physical distance between a remote computer and computer 900 is not important. Network 990 can be a wired or a wireless network. To name a few network implementations, network 990 may comprise, for example: a local area network (LAN); a wide area network (WAN); an intranet; the Internet; a public switched telephone network (PSTN); a Integrated Services Digital Network (ISDN); an infra-red (IR) link; a radio link; a Universal Mobile Telecommunications System (UMTS); a Global System for Mobile Communication (GSM); a Code Division Multiple Access (CDMA) system; and/or a satellite link.

Transmission protocols and data formats are known, such as transmission control protocol/internet protocol (TCP/IP), hyper text transfer protocol (HTTP), secure HTTP, wireless application protocol (WAP), unique resource locator (URL), unique resource identifier (URI), hyper text markup language (HTML), extensible markup language (XML), extensible hyper text markup language (XHTML), wireless application markup language (WML), and Standard Generalized Markup Language (SGML).

Interfaces coupled between the elements are also well known in the art. Accordingly, for simplicity, such interfaces are not illustrated in FIG. 1. An interface can be, for example, a serial port interface, a parallel port interface, a game port, a universal serial bus (USB) interface, an internal or external modem, a video adapter and/or a sound card.

Computers and programs are closely related. As used hereinafter, phrases such as “the computer provides” and “the program provides” are convenient abbreviations to express actions by a computer that is controlled by a program.

As disclosed herein, embodiments of the invention relate to a validation framework for validating input at a client computer. The validation framework may be used in connection with validating a markup language page, such as HTML pages used in Internet applications. Each element in the application that needs validation may include an attribute (called, for example, “validationType”), which comprises a list of all of the kinds of validation that need to be performed on the field. This approach permits the screen developer to include validation without writing any script and without attaching functions to any events. By way of example, an element may be validated as a date and required using the following: <INPUT validationType=“date,required”>.

In one embodiment, if the validation is complex and needs parameters, those parameters may be put into an HTML element. In the example provided below, the field is validated as a date and compared to another field which it is supposed to be equal to. The parameter “displayName” will be passed so that the user will know which field caused the error. The parameter “val_OtherField” specifies which field this must be equal to. Again, no scripting is required for the screen developer even for complex forms of validation like this example:

<INPUT displayName=“Date 3” validationType=“date,comparedateequal”
val_OtherField=“equalDate”>

In another embodiment, validation may be included on fields that are created explicitly or dynamically. In still another embodiment, validation can be triggered by an event or triggered explicitly. For example, event driven validation may be triggered as a user navigates or uses a screen. An explicit call can be made when a form is submitted. The explicit call may cause everything on the screen to be validated.

In one embodiment of the invention, the functionality that is behind each kind of validation may be completely isolated from the screens where validation is used. Each kind of validation can have a different function for any event. For example, a date validation may call one function when the user enters characters into a field in order to prevent characters, such a letters, that should not be part of an entered date. Further, a different function may be called when the user leaves a field to generate a message if the date entered was in the wrong format. Moreover, another function may be called when the form is submitted to perform a final check.

As disclosed herein, the implementation of each kind of validation may be independent of the screens which use validation. Further, the events which trigger the validation can be changed, or the functionality of the validation itself can be changed.

In accordance with still another embodiment of the invention, validation errors are indicated to the user. The way in which validation errors are displayed to a user may be defined in the framework. For instance, errors found before a form is submitted may be displayed on a small pop-up window at the client computer. Other types of error display messages may also be provided, such as event-triggered messages that display a JavaScript alert. This behavior can also be defined as part of the framework.

Other embodiments of the invention will be apparent to those skilled in the art from consideration of the specification and practice of the embodiments disclosed herein. In addition, embodiments of the invention are not limited to the particulars disclosed herein. For example, the individual features of each of the disclosed embodiments may be combined or added to the features of other embodiments. In addition, the steps of the disclosed methods herein may be combined or modified without departing from the spirit of the invention claimed herein. Accordingly, it is intended that the specification and embodiments disclosed herein be considered as exemplary only, with a true scope and spirit of the invention being indicated by the following claims.

What is claimed:

1. A method for operating a server computer and a client computer, the method comprising:
sending a validation rule file from the server computer to the client computer;
sending a markup language page from the server computer to the client computer;
receiving a first input value by the client computer, the first input value corresponding to a first input field represented in the page by first input field code;
receiving a second input value by the client computer, the second input value corresponding to a second input field represented in the page by second input field code;
identifying a rule in the validation rule file from attributes in the first input field code and in the second input field code;
applying the rule to the first input value and the second input value; and
providing a message to a user of the client computer depending on the result of applying the rule.

2. The method of claim 1, wherein sending a validation rule file is performed prior to sending a markup language page.

3. The method of claim 1, wherein receiving first and second input values comprises receiving values from a user of the client computer who operates a keyboard.

4. The method of claim 1, wherein identifying a rule in the rule file comprises reading a JavaScript file.

5. The method of claim 1, wherein applying the rule comprises validating input values of each input field separately.

6. The method of claim 1, wherein applying the rule comprises validating input values for both input fields in combination.

7. The method of claim 1, wherein the input field code is markup code and the attributes are part of the markup code.

8. The method of claim 1, wherein providing the message comprises providing a message with an indication of the input field to which the rule has been applied.

9. The method of claim 1, wherein the first and second input field code comprise further attributes to cross-reference the first and second input values.

10. The method of claim 1, wherein the first input field code and the second input field code are represented in the page by code that causes a browser in the client computer to generate code upon receiving the page.

11. The method of claim 1, wherein the rule file binds the rules to functions in libraries.

12. The method of claim 1, wherein applying the rule is triggered upon the occurrence of an event.

13. The method of claim 1, wherein applying the rule is triggered upon a predetermined user interaction.

14. The method of claim 13, wherein the predetermined user interaction comprises one of: operating submit button; operating a predetermined key on a computer keyboard; and leaving the input field.

15. The method of claim 1, wherein the first value and second value are first and second calendar dates, and wherein applying the rule comprises determining an error condition, the error condition comprising one of: the first date antecedes the second date; the first date precedes the second date; the first date and the second date coincide; an input number for a day is larger than 31 or smaller than 1; and an input number for a month is larger than 12 or smaller than 1.

16. The method of claim 1, wherein the server computer and the client computer communicate by TCP/IP and wherein the page is a HTML page.

17. A method for operating a server computer and a client computer, the method comprising:
sending a behavior rule file from the server computer to the client computer;
sending a markup language page from the server computer to the client computer, the page including at least one input field code;
identifying a rule in the behavior rule file from attributes in the input field code;
applying the rule to the input field; and
providing a message to a user of the client computer depending on the result of applying the rule.

18. The method of claim 17, wherein sending a behavior rule file comprises sending a validation rule file.

19. The method of claim 17, wherein providing a message comprises providing a message indicating a change in the behavior of the input fields.

20. The method of claim 17, wherein identifying a rule in the behavior rule file comprises reading a JavaScript file.

21. The method of claim 17, wherein applying the rule is triggered upon a predetermined user interaction.

22. The method of claim 21, wherein the predetermined user interaction comprises one of: operating submit button; operating a predetermined key on a computer keyboard; and leaving the input field.

23. A computer program product embodied on a computer usable medium, for operating a server computer and a client computer, the computer program product comprising:
instructions to the server computer for sending a validation rule file to the client computer;
instructions to the server computer for sending a markup language page to the client computer;
instructions to the client computer for receiving a first input value, the first input value corresponding to a first input field represented in the page by first input field code;
instructions to the client computer for receiving a second input value by the client computer, the second input value corresponding to a second input field represented in the page by second input field code;
instructions to the client computer for identifying a rule in the validation rule file from attributes in the first input field code and in the second input field code;
instructions to the client computer for applying the rule to the first input value and to the second input value; and
instructions to the client computer for providing a message to the user of the client computer depending on the result of applying the rule.

24. The computer program product of claim 23, wherein the instructions for receiving first and second input values are provided to receive values from a user who operates a keyboard of the client computer.

25. The computer program product of claim 23, wherein the instructions for identifying a rule in the rule file comprise instructions to read a JavaScript file.

26. The computer program product of claim 23, wherein the instructions for applying the rule comprise instructions to validate input values of each input field separately.

27. The computer program product of claim 23, wherein the instructions for applying the rule comprise instructions to validate input values for both input fields in combination.

28. The computer program product of claim 23, wherein the instructions for providing a message comprise instructions to provide an indication of the input field to which the rule has to be applied.

29. The computer program product of claim 23, wherein the first input field code and the second input field code are represented in the page by code that causes a browser in the client computer to generate code upon receiving the page.

30. The computer program product of claim 23, wherein the first value and second value are first and second calendar dates, and wherein applying a rule comprises determining an error condition, the error condition comprising one of: the first date antecedes the second date; the first date precedes the second date; the first date and the second date coincide; an input number for a day is larger than 31 or smaller than 1; and an input number for a month is larger than 12 or smaller than 1.

31. A computer-readable medium on which is stored instructions, which when executed performs steps in a method for operating a server computer and a client computer, the steps comprising:
sending a validation rule file from the server computer to the client computer;
sending a markup language page from the server computer to the client computer;
receiving a first input value by the client computer, the first input value corresponding to a first input field represented in the page by first input field code;
receiving a second input value by the client computer, the second input value corresponding to a second input field represented in the page by second input field code;
identifying a rule in the validation rule file from attributes in the first input field code and in the second input field code;
applying the rule to the first input value and to the second input value; and
providing a message to (a user of the client computer depending on the result of applying the rule.

32. A computer system of server computer and client computer that communicate to provide a presentation on the client computer, wherein:
the server computer is adapted to send a validation rule file to the client computer;
the server computer is adapted to send a markup language page to the client computer;
the client computer is adapted to receive a first input value, the first input value corresponding to a first input field represented in the page by first input field code;
the client computer is adapted to receive a second input value, the second input value corresponding to a second input field represented in the page by second input field code;
the client computer is adapted to identify a rule in the validation rule file from attributes in the first input field code and in the second input field code;
the client computer is adapted to apply the rule to the first input value and to the second input value; and
the client computer is adapted to provide a message to the user of the client computer depending on the result of rule application.

33. A computer program product for controlling the operation of a server computer and a client computer, the program comprising the following code portions:
code for sending a behavior rule file from the server computer to the client computer;
code for sending a markup language page from the server computer to the client computer, the page including at least one input field code;
code for identifying a rule in the behavior rule file from attributes in the input field code;
code for applying the rule to the input field; and
code for providing a message to a user of the client computer depending on a result of applying the rule.

34. The computer program product of claim 33, wherein the code for sending a behavior rule file comprises code for sending a validation rule file.

35. The computer program product of claim 33, wherein the code for providing a message comprises code for providing a message indicating a change in the behavior of the input fields.

36. The computer program product of claim 33, wherein the code for identifying a rule in the behavior rule file comprises code for reading a JavaScript file.

37. The computer program product of claim 33, wherein the code for applying the rule is triggered upon a predetermined user interaction.

38. The computer program product of claim, 33, wherein the predetermined user interaction comprises one of: operating submit button; operating a predetermined key on a computer keyboard; and leaving the input field.

39. The computer program product of claim 33, further comprising code for sending a plurality of markup language pages from the server computer to the client computer, each page including at least one input field code.

40. The computer program product of claim 39, further wherein the code for applying the rule comprises code for applying the rule consistently to the plurality of markup language pages.
